(19) United States
(12) Patent Application Publication
(10) Pub. No.: US 2012/0074867 A1
(43) Pub. Date: Mar. 29, 2012

(54) LED LIGHTING DEVICE FOR AN ELECTRIC BED

(76) Inventor: Lung-Tan Shih, Lukang Town (TW)

(21) Appl. No.: 12/891,572

(22) Filed: Sep. 27, 2010

(51) Int. Cl. H05B 37/02

(52) U.S. Cl. 315/294

(57) ABSTRACT

An LED lighting device for an electric bed has at least one LED light strip installed on a bottom side of a support frame of the electric bed, the LED light strip comprising a plurality of LED lights; a control box installed on the electric bed and supplying power to the LED light strip, the control box having a transformer and a switchable power supply electrically connected together; wherein when an alternating current passes through the control box, the transformer converts the alternating current into a direct current that is output through the switchable power supplier to the LED light strip; and a remote capable of controlling the electric bed and communicating with an electric switch of the control box.

### BACKGROUND OF THE INVENTION

1. Field of the Invention

The present invention relates to an LED lighting device for an electric bed.

2. Description of the Related Art

Typically, in a shared room in hospital wards or dormitories, to get out of bed at night, an individual may need to turn on an indoor lamp or light to provide illumination, which is likely to disturb other roommates. Furthermore, the illumination provided by lamps or lights has difficulty reaching under the bed, making it difficult to find, for example, slippers. Without turning on the light, the indoor light is insufficient for vision; this may lead to the risk of individuals bumping into or tripping over objects, and therefore, whether or not to turn on a light poses a dilemma.

Therefore, it is desirable to provide an LED lighting device for an electric bed to mitigate and/or obviate the aforementioned problems.

### SUMMARY OF THE INVENTION

An objective of the present invention is to provide an improved reflective structure.

Another objective of the present invention is to provide an improved reflective structure that is relatively thinner and capable of covering the entire object surface for better reflection effects.

Another objective of the present invention is to provide an improved reflective structure that can improve the safety of the bicycle for riders at night.

In order to achieve the above-mentioned objectives, an electric bed is installed with a lifting motor which is used to lift at least a portion of the electric bed 10. Four LED light strips are installed on a bottom side of a support frame of the electric bed. The LED light strips are directly attached to both sides of the bottom side of the support frame or one of the two sides of the bottom side of the support frame. Each LED light strip comprises a plurality of LED lights, and the plurality of LED light strips are connected in parallel and disposed at different positions. A control box is installed on the electric bed and supplies power to the LED light strips. The control box has a transformer and a switchable power supply electrically connected together. When an alternating current passes through the control box, the transformer converts the alternating current into a direct current that is output through the switchable power supply for regulation, and then to the LED light strip. Furthermore, the electric bed is controlled by a remote and the remote is capable of communicating with an electric switch and circuit boards in the control box, such that a user can control the LED light strip on the electric bed.

With the LED light device for the electric bed, when the user wants to get up and move around at night, he or she can use the remote on the electric bed to control the LED light strip. When the LED light strip is turned on it provides illumination from the bottom of the support frame near to the ground, such that the user can easily find slippers or the like,. Furthermore, since the position of the LED light strip is relatively lower and only covers the area close around the support frame, it can reduce disturbances to other roommates to a minimum. In addition, when the user can control the LED light strip on the electric bed via the remote, he or she can avoid the danger of bumping into or tripping over objects.

Other objects, advantages, and novel features of the invention will become more apparent from the following detailed description when taken in conjunction with the accompanying drawings.

### BRIEF DESCRIPTION OF THE DRAWINGS

FIG. 1 illustrates an embodiment of the present invention.

FIG. 2 is a schematic drawing of an LED light strip and a control box according to an embodiment of the present invention.

FIG. 3 is a perspective top view of an electric bed according to an embodiment of the present invention.

FIG. 4 is a local detailed view of an LED light strip according to an embodiment of the present invention.

FIG. 5 is a local detailed view of another embodiment of an LED light strip according to the present invention.

FIG. 6 is a usage schematic drawing of an embodiment of the present invention.

### DETAILED DESCRIPTION OF THE PREFERRED EMBODIMENT

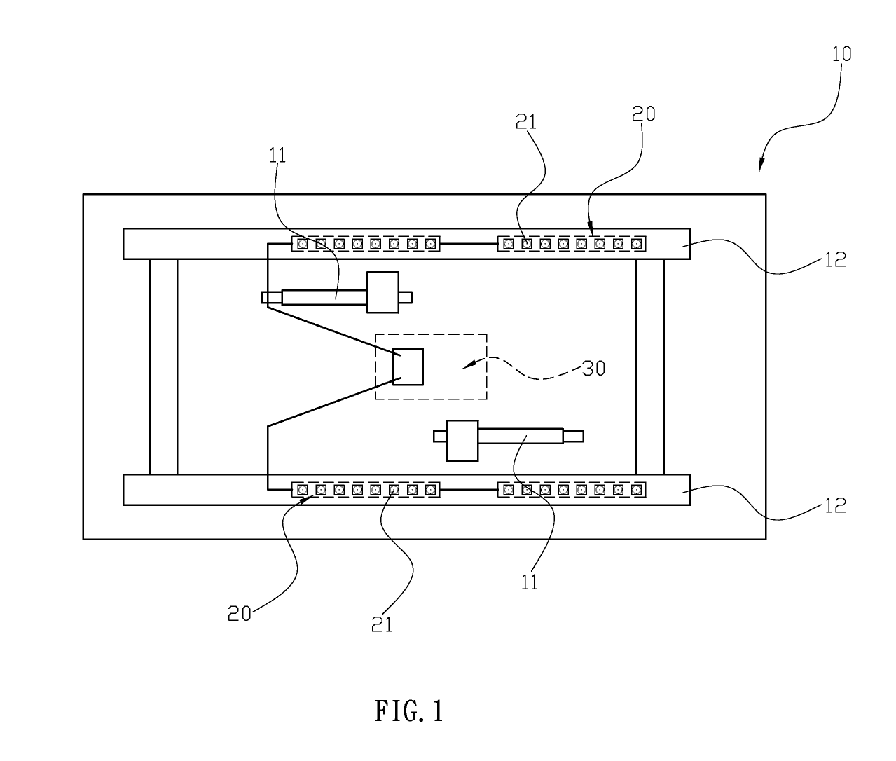

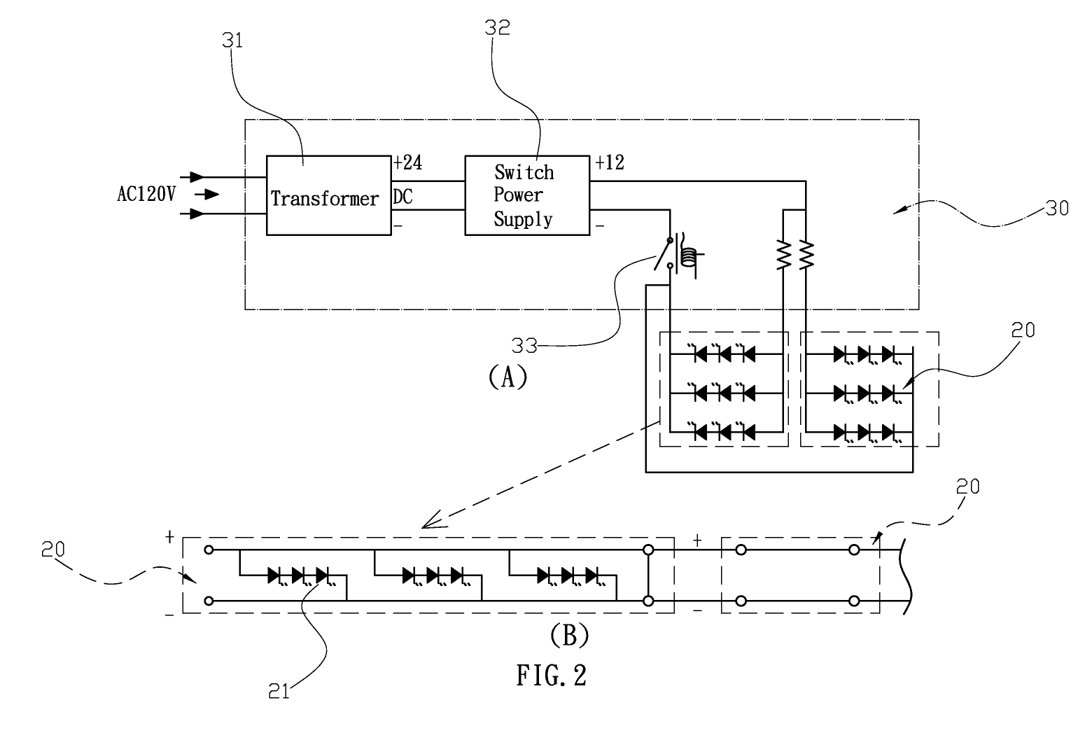

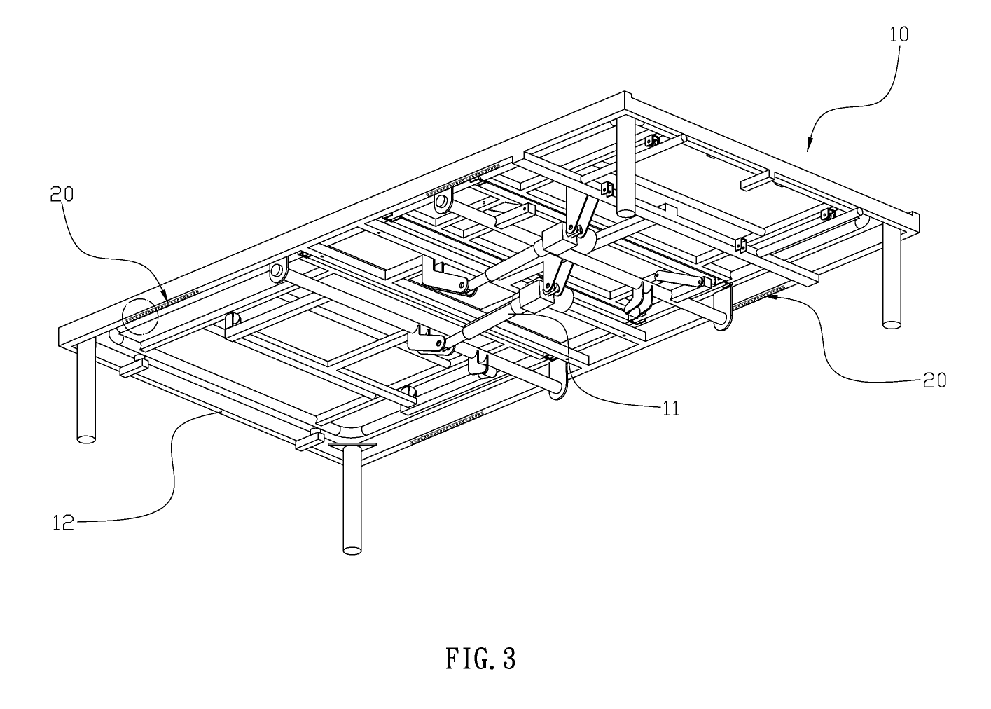

Please refer to FIG. 1, FIG. 2 and FIG. 3. An electric bed 10 is installed with a lifting motor 11 which is used to lift at least a portion of the electric bed 10. Four LED light strips 20 are installed on a bottom side of a support frame 12 of the electric bed 10. The LED light strips 20 are directly attached to both sides of the bottom side of the support frame 12 or one of the two sides of the bottom side of the support frame 12. Each LED light strip 20 comprises a plurality of LED lights 21, and the plurality of LED light strips 20 are connected in parallel and disposed at different positions (as shown in portion (B) of FIG. 2.). A control box 30 is installed on the electric bed 10 and supplies power to the LED light strips 20 (as shown in portion (A) of FIG. 2.). The control box 30 has a transformer 31 and a switchable power supply 32 electrically connected together. When an alternating current passes through the control box 30, the transformer 31 converts the alternating current into a direct current that is output through the switchable power supply 32 for regulation, and then to the LED light strip 20. Furthermore, the electric bed 10 is controlled by a remote and the remote is capable of communicating with an electric switch 33 and circuit boards in the control box 30, such that a user can control the LED light strip 20 on the electric bed 10.

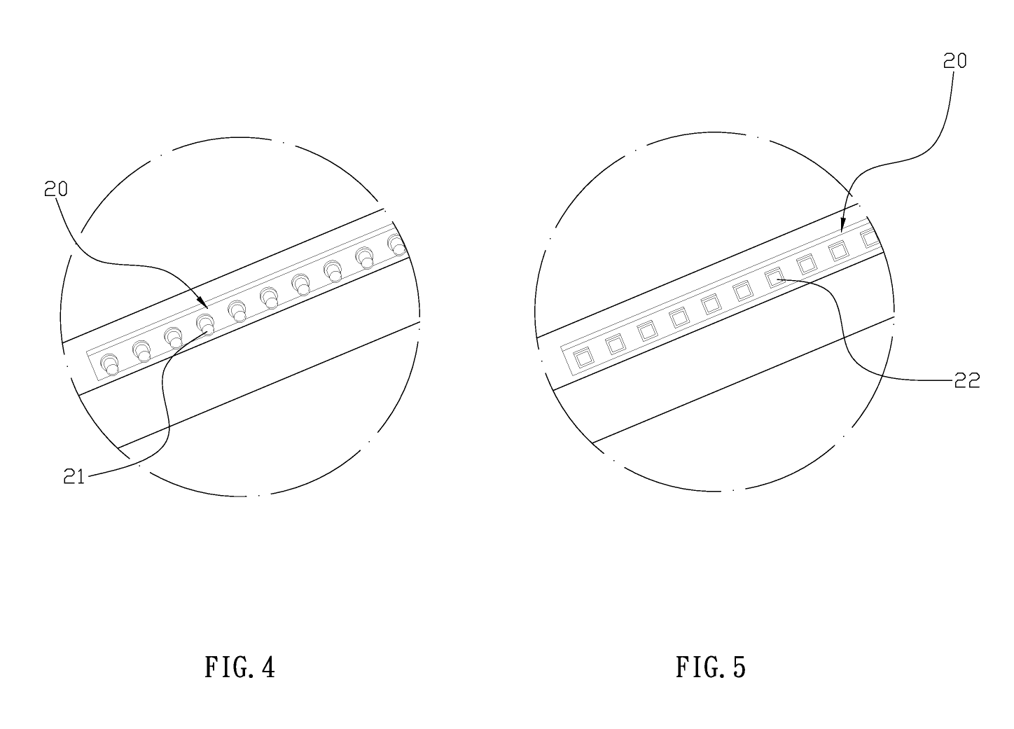

Please refer to FIG. 4. Each LED light strip 20 comprises a plurality of LED lights 21 that are serially connected, and the plurality of LED light strips 20 are connected in parallel, disposed at different positions, and controlled by the remote. Alternatively, as shown in FIG. 5, each LED light strip 20 comprises a plurality of chip LED lights 22 connected in series, and the plurality of LED light strips 20 are connected in parallel, disposed at different positions, and controlled by the remote, such that the LED light strip 20 is also capable of providing a flashing illumination.

The remote can be a wired remote or a wireless remote. When the remote is a wired device, it is electrically connected to the control box 30 to send signals to the electric switch 33. When the remote is a wireless device, it is wirelessly connected to the control box 30 to send signals to the electric switch.

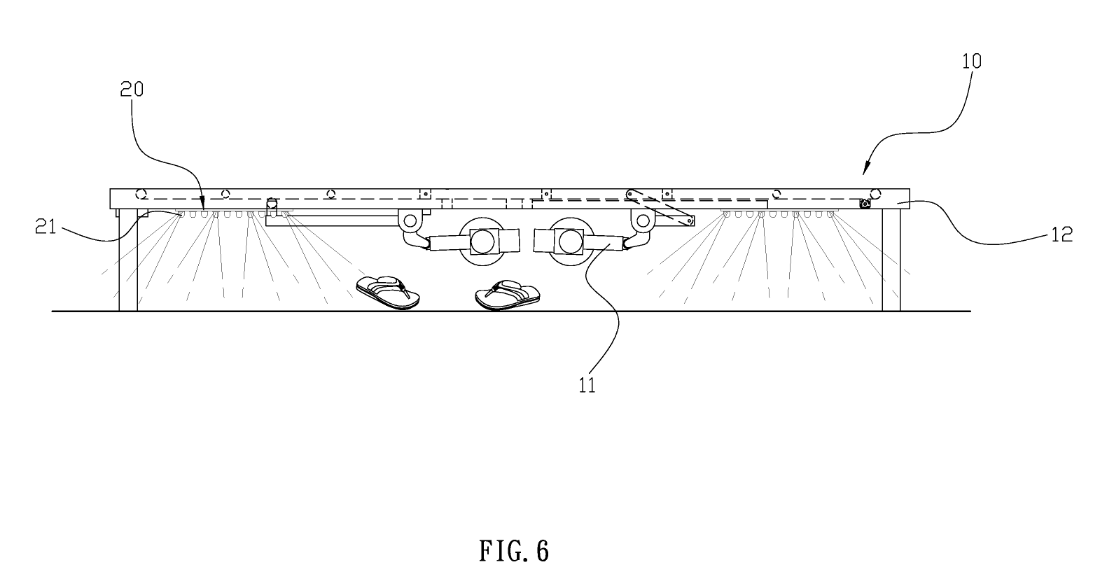

With the LED light device for the electric bed, when the user wants to get up and move around at night, he or she can use the remote on the electric bed 10 to control the LED light strip 20. When the LED light strip 20 is turned on it provides illumination from the bottom of the support frame 12 near to the ground, such that the user can easily find slippers or the like, as shown in FIG. 6. Furthermore, since the position of the LED light strip 20 is relatively lower and only covers the area close around the support frame 12, it can reduce disturbances to other roommates to a minimum. In addition, when the user can control the LED light strip 20 on the electric bed 10 via the remote, he or she can avoid the danger of bumping into or tripping over objects.

Although the present invention has been explained in relation to its preferred embodiment, it is to be understood that many other possible modifications and variations can be made without departing from the spirit and scope of the invention as hereinafter claimed.

What is claimed is:

1. An LED lighting device for an electric bed comprising:
at least one LED light strip installed on a bottom side of a support frame of the electric bed, the LED light strip comprising a plurality of LED lights;
a control box installed on the electric bed and supplying power to the LED light strip, the control box having a transformer and a switchable power supply electrically connected together; wherein when an alternating current passes through the control box, the transformer converts the alternating current into a direct current that is output through the switchable power supplier to the LED light strip; and
a remote capable of controlling the electric bed and communicating with an electric switch of the control box.

2. The LED light device for an electric bed as claimed in claim 1, wherein a lifting motor is disposed in the electric bed and used to lift at least a portion of the electric bed.

3. The LED light device for an electric bed as claimed in claim 1, wherein the LED light strip is directly attached to one side of the bottom side of the support frame.

4. The LED light device for an electric bed as claimed in claim 1, wherein the LED light strip is attached to a left side of the bottom side of the support frame.

5. The LED light device for an electric bed as claimed in claim 1, wherein the LED light strip is attached to a right side of the bottom side of the support frame.

6. The LED light device for an electric bed as claimed in claim 1, wherein the remote is a wired device that is electrically connected to the control box to send signals to the electric switch.

7. The LED light device for an electric bed as claimed in claim 1, wherein the remote is a wireless device that is wirelessly connected to the control box to send signals to the electric switch.

8. The LED light device for an electric bed as claimed in claim 1, wherein the LED light strip is a chip LED that is cable of providing flashing light.

9. The LED light device for an electric bed as claimed in claim 1, wherein the LED light strip illuminates an area surrounded by the support frame.
